(19) United States
(12) Patent Application Publication
(10) Pub. No.: US 2016/0246790 A1
(43) Pub. Date: Aug. 25, 2016

(54) AUTOMATED USER PROFILE MATCHING AND COMMUNICATION

(71) Applicant: Plum Social INC, Coppell, TX (US)

(72) Inventors: Russell Paul Cowdrey, Coppell, TX (US); Jason Hemmings Cone, Denton, TX (US)

(21) Appl. No.: 14/627,766

(22) Filed: Feb. 20, 2015

(51) Int. Cl. G06F 17/30

(52) U.S. Cl. CPC G06F 17/3053; G06F 17/30867; G06F 17/30887; G06F 17/30598

(57) ABSTRACT

User profiles associated with a social networking application may be updated and compared to identify potential user interests and groups for users to connect and meet via their user devices. One example method of operation provides identifying a number of user profiles stored on a server comparing the user profiles to a predetermined category and creating numerical scores corresponding to each of the user profiles. The method may also include filtering the numerical scores based on a predetermined threshold value, and establishing a group for the user profiles which are above the predetermined threshold value.

### TECHNICAL FIELD OF THE APPLICATION

This application relates to an application used with social networking platforms, and more particularly, to establishing a connection between users based on established interests.

### BACKGROUND OF THE APPLICATION

Conventionally, social media-based platforms are shallow and truly meaningless ways to actually connect people with common interests. Almost all social networks are geared around one of two models: “Friend of a Friend”, such as Facebook®, Snapchat®, LinkedIn® or Self-selecting common interests, such as Pinterest®, Vingle®, Whisper.sh®, Instagram®, i.e., I like your picture® and Twitter®, Reddit®, i.e., I like what you say. Neither of those models permit a user to find people like themselves without that person being part of their social graph or by manually seeking out those connections by trolling through massive volumes of content in the Twitter® and Pinterest® examples.

Also, conducting manual web searches that lead to specialty forums are becoming more difficult with the advent of privacy controls and regulations like HIPPA. There are opportunities to exploit these short comings by providing better information about the people we connect with and by making new connections more efficient. Today, peoples' behaviors are tracked everywhere. Businesses use behavioral tracking to personalize marketing strategies and increase sales. Governments track their citizens' behavior to determine threats to the general population and even suppress basic human rights. Privacy and security discussions are at an all-time high. There is an opportunity to have the people sharing their behaviors with each other to create deeper, more relevant connections in an environment that is anonymous, transparent, and respects the users' privacy.

### SUMMARY OF THE APPLICATION

One example embodiment of the present application may provide a method that includes at least one of identifying a plurality of user profiles stored on a server, comparing the plurality of user profiles to a predetermined category, creating a plurality of numerical scores corresponding to each of the plurality of user profiles, filtering the plurality of numerical scores based on a predetermined threshold value, and establishing a group for the user profiles which are above the predetermined threshold value.

Another example embodiment includes at least one of an apparatus with a processor configured to identify a plurality of user profiles stored on a server, compare the plurality of user profiles to a predetermined category, create a plurality of numerical scores corresponding to each of the plurality of user profiles, filter the plurality of numerical scores based on a predetermined threshold value, and establish a group for the user profiles which are above the predetermined threshold value, and a transmitter configured to transmit invites to user devices associated with the user profiles.

Another example embodiment of the present application may provide a non-transitory computer readable medium with a processor configured to perform at least one of identifying a plurality of user profiles stored on a server, comparing the plurality of user profiles to a predetermined category, creating a plurality of numerical scores corresponding to each of the plurality of user profiles, filtering the plurality of numerical scores based on a predetermined threshold value, and establishing a group for the user profiles which are above the predetermined threshold value.

### BRIEF DESCRIPTION OF THE DRAWINGS

FIG. 1 illustrates a logic diagram of the operations of the application according to example embodiments.

FIG. 2 illustrates a logic diagram of the data organization of the application according to example embodiments.

FIG. 3 illustrates a logic diagram of the operations of the data configuration of the application according to example embodiments.

FIG. 4 illustrates a flow diagram of the operations of the application identifying user behavior according to example embodiments.

FIG. 5 illustrates a user interface of a topic and sub-topic according to example embodiments.

FIG. 6A illustrates another user interface of a business category associated with a people finding option according to example embodiments.

FIG. 6B illustrates an example user interface of a user set of menu options for accessing and enabling multiple users of the application according to example embodiments.

FIG. 6C illustrates another example user interface of a user set of menu options for accessing and enabling default user interests of the application according to example embodiments.

FIG. 7 illustrates a user interface of a URL access performed and incorporated into the application according to example embodiments.

FIG. 8 illustrates a logic diagram of the data categorization of the application according to example embodiments.

FIG. 9 illustrates a user interface of the user data feeds utilized by the application according to example embodiments.

FIG. 10 illustrates a logic diagram of the data categorization of the application according to example embodiments.

FIG. 11 illustrates a logic diagram of the group organization of the application according to example embodiments.

FIG. 12 illustrates a logic diagram of the group statistics calculated by the application according to example embodiments.

FIG. 13 illustrates a control logic configuration configured to perform logic calculations based on the various data inputs according to example embodiments.

FIG. 14 illustrates a system signaling diagram according to example embodiments.

FIG. 15 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments of the present application provide a social network and social media analytics application that automatically connects people based upon common interests which are automatically identified, weighted, compared and/or matched to those of other user accounts. For example, a newly-diagnosed cancer patient searching, posting and interacting with online web sites, social network platforms, etc., will quickly find other cancer patients with similar characteristics and possibly even in her home town. In another example, a business traveler during a long layover at the airport may connect with other travelers who support his favorite interest (i.e., sports team, etc.). The above examples illustrate the functions and results of the software application of the example embodiment. In addition to creating new social connections, the application provides any social network user a way to understand more about their network of friends, followers and business connections.

In another example, behavioral tracking is performed to help users understand their current connections better and to connect with people who share their common interests. A behavioral profile may be setup from the URLs (uniform resource link or web pages) a user visits. The application then matches users based on how closely their behavioral profiles match. Then users may join communities based on common browsing categories such as sports and/or politics or more specifically football.

In another example, if a user adds a link to one of their existing social network accounts (FACEBOOK, TWITTER, LINKEDIN, etc.), the application will ask if they would like to understand the behavioral profiles of their connections. If they would like to gain this insight, the application will submit a question to the user to determine if it can post to their network. Upon agreement, an invitation will post from the user to their connections asking that their connections join the application, along with a brief description of the application's benefits. From the connections that join the application, a behavioral profile for the entire population will be built and presented to the initial user via an easy to understand dashboard.

Data generated by the application from a user's connections can be shared with those connections through existing social networks. The application will proactively suggest threshold based statistics (percentage relevancy) to share with the user's connections. For example, the application can tell what percentage of a user's connections are dog lovers versus cat lovers or conservatives versus progressives. There can be thousands of other data points to share. For the application users who install the application via a desktop browser, the application will begin interacting with the user immediately. The user can connect with previous site visitors, join a community built around a category or website and/or follow suggested links to similar websites.

Mobile device users can use the application to see application profiles and dashboards. The users will also be able to use the application to connect with people like them by setting category, demographic, and/or proximity filters. Mobile device users can also connect directly to people like them or join communities based on common interests among the various users. Connection requests can be as simple as wanting to talk to someone at the local Starbucks® or maybe you are a young Korean mother new to the area who would like to find similar mothers to set up play dates. Whatever the interests, the application makes it possible to connect with other users and it can also serve as an ice-breaker in light of the information known about the person with whom you are connecting.

An application programming interface (API) may be provided so that a business, organization, or group can easily add their users to the application in order to have access to their analytics, build custom applications, and allow their users to find connections.

The top three social networks with the millennial and post-millennial generations are Instagram®, Twitter® and Snapchat®. These three social networks each follow an anonymous user configuration as opposed to a named user system like Facebook®. They provide some degree of privacy by anonymity, and two of the three facilitate connecting with those outside of the user's immediate social group. The application of the present disclosure is built upon similar differentiators with the millennial and post-millennial generations including anonymity and connecting with those who share common interests.

The application may use social network analytic features to grow the application's popularity. One approach is to target key social media users to quickly gain large numbers of users in key demographics. For example, popular singers, such as Taylor Swift and Katy Perry have very large post-millennial followings and the application would give them huge insight into their followers' behaviors if utilized on the existing social networking platforms. Another approach is to provide an affiliate marketing program that pays offline organizations such as AARP, American Heart Association, alumni associations, specialty blogs and sports-targeted websites to recruit their users through the application. Other features include selling analytics to large brands and digital agencies that manage these brands to have them virally push recruiting through their social media accounts. Additionally, the application API could be used to attract companies with large user bases that could utilize behavioral matching in already existing applications (e.g., dating services).

The application's ability to automatically calculate how closely two or more of the application users' behavior profiles match, its ability to continuously match users as behaviors change or new users join the application, and the ability to derive insights about the users' existing connections provides optimal results for the social networking market and social media analytics markets.

Examples of questions that can be used to setup the application for use may include the user's age, gender, ethnicity/nationality, primary language, dating status, interests, occupation, health status, exercise preferences, hobbies, vacation interests, family status, etc. Other information may include favorite categories, such as favorite pets (i.e., 45% dogs, 33% cats, 8% fish, 5% birds, and 10% other), political leaning (i.e., 25% conservative, 38% progressive, 40% undecided), religious interests, favorite sports, favorite social media sites, favorite food site, travel interests, top 10 interests, top 10 shopping sites, top news sites.

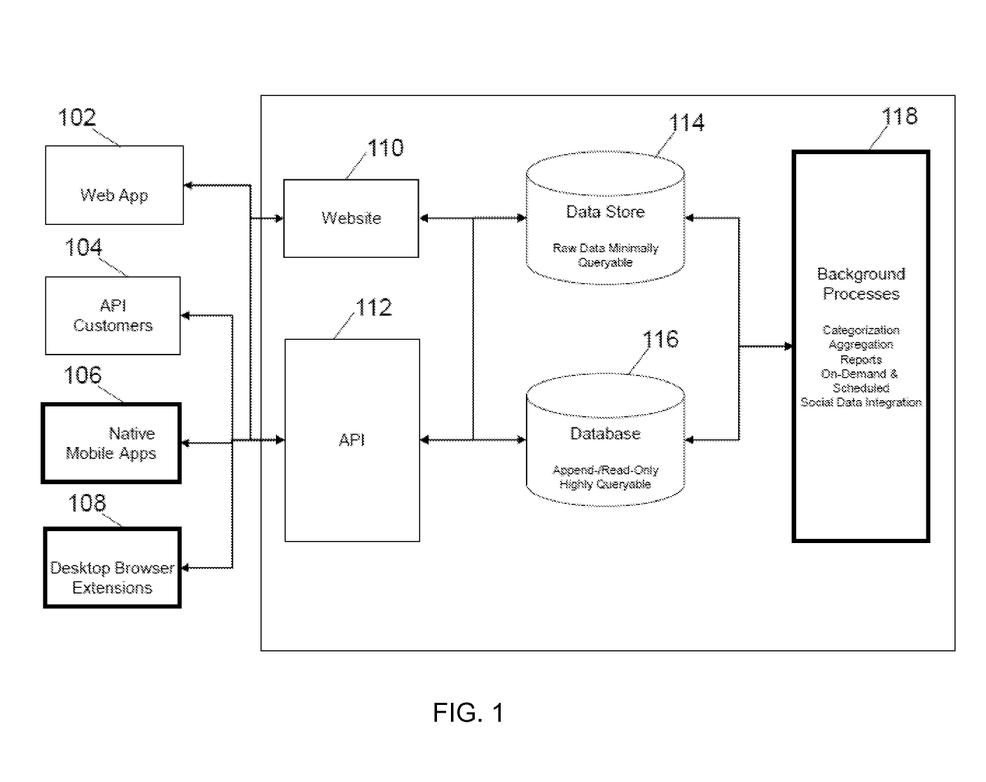

FIG. 1 illustrates an example logic diagram of the application architecture according to example embodiments. The web application of the present application 102 is linked to an API 112 of the back end functions. Also, the API for customers 104, the native mobile applications 106 and the desktop browser extensions 108 may all be linked to the API 112 of the back end functions. The website 110 that is visited by the user may be linked to a data store 114 for querying purposes and another database 116 for more highly relevant query data. The background processes 118 may include categorization, aggregation, reports, and social data integration of the data.

The URL's accessed by the user may be used for scoring of a user's interest profile. Initially, URLs from the user's history of searching, search keywords and sites visited (i.e., user profile) have the ability to be categorized using a third party service. This provides a profile setup and contextual analysis of the user behavior. Keyword mapping\metatags may be provided by the pages as well as keyword density algorithms to setup different sub-categories under each category identified for the user.

There are two primary processes that the application may use to connect people, the first is scoring which is the process of assigning a numeric value to a user within the context of a given category based on their behavior tracked and logged by a user profile management module. Another process may include matching and/or comparing the various scores of two different users across a set of categories and determining how similar the users are to one another. Because scoring is where most of the work is performed and because it's performed for each user, this process is performed in the background at a predetermined time interval and/or in response to a set of triggers. Scoring may be performed during each run and matching may be performed on-demand. The data involved in both scoring and matching is assigned a weight. For instance, the top sites that the browser has identified for a user counts toward 40% of the overall score and maybe be 2, 3, or even 4 times more important than the applications that the user accesses on the user device.

In operation, data is normalized on a scale of 0.0-1.0. That is, any given data point, such as a single top web site is only capable of contributing a maximum of 1.0 to any given category. That value is then normalized using weights and then aggregated and normalized based on the size of the data set. Additionally, individual data points are originally modified based on the following criteria before the weights are applied. If the site is not a current top site, but once was, the most that it can earn is 0.1 vs. 1.0. A site that was originally recognized as a top site previously is going to earn more than a site that was just recently recognized as a top site. A web page that is frequently visited is going to earn more weight than a page that is seldom visited. A web page that was recently visited is going to earn more than a page that was visited in the past. If a bookmark site has since been deleted, the most that it can earn is 0.1 (vs. 1.0). A bookmark site that was recently added will earn more than a more aged bookmark site. If the application has since been uninstalled, the most that it can earn is 0.1 (vs 1.0). If the browser is installed, but is disabled, the most that it can earn is 0.5 (vs 1.0). An application that was recently added will earn less than an application that's been installed for a while. Each possible demographic classification (e.g., male, female, kids, no kids, caucasian, hispanic, location, etc.) will correspond to its own specialized category. Declared classifications will be assigned a value of 1.0 with the other classifications within the demographic being assigned a value of 0.0. For example, if a user indicates that they are a male, then the “male” category will be assigned a value of 1.0 and the “female” category will be assigned a value of 0.0. Undeclared classifications will result in a value of 0.1 being assigned to all categories associated with the demographic. For example, if a user does not indicate their gender, then both the “male” and “female” categories will be assigned a value of 0.1.

An example of the code used to establish a score for user categories is identified below:

Psuedo Code (Python)

| | |
|---|---|
| _MODIFIER_TOP_SITE | = 0.40 |
| _MODIFIER_PAGE_VISIT | = 0.30 |
| _MODIFIER_BOOKMARK | = 0.15 |
| _MODIFIER_APP | = 0.10 |
| _MODIFIER_DEMOGRAPHIC | = 0.05 |

me.ScoredCategories = { }
for topSite in me.TopChromeSites:

score = (1.0 * (1.0 if inLastDay(topSite.LastSeenOn)

else 0.1) * getEstablishedModifier(topSite.DiscoveredOn) *
_MODIFIER_TOP_SITE)

for category in topSite.Categories:

me.ScoredCategories[category].Score += score
me.ScoredCategories[category].ScoreCount += 1

totalPageVisits = getUserPageVisitCount(me)
for pageVisit in me.PageVisits:
score = ( (pageVisit.Visits / totalPageVisits) *

getFreshnessModifier(pageVisit.Day) * _MODIFIER_PAGE_VISIT)

for category in pageVisit.Categories:

me.ScoredCategories[category].Score += score
me.ScoredCategories[category].ScoreCount += 1

for bookmark in me.Bookmvarks:

score = (1.0 * (1.0 if inLastDay(bookmark.LastSeenOn)

else 0.1) * getFreshnessModifier(bookmark.DiscoveredOn) *
_MODIFIER_BOOKMARK)

for category in bookmark.Categories:

me.ScoredCategories[category].Score += score
me.ScoredCategories[category].ScoreCount += 1

for app in me.ChromeApps:

score = (1.0 * ((1.0 if app.Enabled else 0.5) if

inLastDay(app.LastSeenOn) else 0.1) *
getEstablishedModifier(app.DiscoveredOn) * _MODIFIER_APP)

for category in app.Categories:

me.ScoredCategories[category].Score += score
me.ScoredCategories[category].ScoreCount += 1

GenerateDemographicScores(me)

for category, scoredCategory in

me.ScoredCategories.items( ):

category.ScoredUsers[me] = scoredCategory.Score /=

scoredCategory.ScoreCount.

Each category in the application uses a reverse index to identify the category users that have been explicitly scored in that category. Matching is simply the process of starting with a reference user, such as the user that we're attempting to find matches and a set of categories. For each of the categories in which the reference user has been scored, the category users for that category may be identified and updated based on the given category user's match score with the product of the reference user's category score and the category user's category score. This results in a higher category match score (relevancy score) if both users are scored highly in the category or sub-category. Then, the matched users are reverse sorted according to their average category match scores.

Another approach is to find users that are similar to other users, for example, by identifying the top users for a given category. Also, finding the most active categories or the most “interesting” users significantly scored in the most categories.

Another example of code used to match users is provided in the following Psuedo Code (Python):

similarUsers = { }
for category, myScore in me.ScoredCategories:

for user, theirScore in category.ScoredUsers:

if me != user:

similarUsers[user].Score += (myScore *

theirScore)

similarUsers[user].ScoreCount += 1

similarUsers = sorted(

similarUsers.items( ),
key = lambda userTuple: userTuple[1].Score /

userTuple[1].ScoreCount

reverse = True

)
Matching Scenario (RPC).

One specific example using a category, such as sports and a score in that category is provided below. Assuming the four users are named James, Michael, David, and Jennifer. James has the following sports scores and categories:

Sports: 35% of all activity

Football: 75% of all sports activity

NCAA: 95% of Football activity

Texas A&M 90% of NCAA

Texags.com 95% of Texas A&M

Other 10% of NCAA
NFL: 5%
Dallas Cowboys 90% of NFL
Other 5% of NFL

General: 10% of all sports activity

Sports News 100% of general

ESPN.com 90%
other news 10%
Basketball 15%

NBA 80% of Basketball
Dallas Mavericks 80% of NBA

dallasbasketball.com 100% of Dallas Mavericks

Other 20% of NBA
NCAA 10% of Basketball

Texas A&M 70% of NCAA

aggieathletics = 100% of Texas A&M

Other 30%.

David has the following sports scores and categories.

Sports: 30% of all activity

Football: 50% of all sports activity

NCAA: 85% of Football activity

Texas A&M 90% of NCAA

Texags.com 95% of Texas A&M

Other 10% of NCAA
NFL: 15%

Houston Texans 90% of NFL

Other 5% of NFL
General: 10% of all sports activity
Sports News 100% of general

ESPN.com 90%
other news 10%

Basketball 40%

NBA 80% of Basketball

Dallas Mavericks 60% of NBA

dallasbasketball.com 100% of Dallas

Mavericks

Houston Rockets 20% of NBA
cluchcity.com 100% of Houston Rockets

Other 20% of NBA
News 20% of Basketball
Texas A&M 70% of NCAA

aggieathletics = 100% of Texas A&M

Other 30%.

Michael has the following sports scores and categories.

Sports: 20% of all activity

Football: 75% of all sports activity

NCAA: 60% of Football activity

Texas Longhorns 90% of NCAA
orangebloods.com 95% of Texas Longhorns

Other 10% of NCAA
NFL: 40%

Dallas Cowboys 95% of NFL

Assorted Cowboys sites

Other 5% of NFL
General: 10% of all sports activity
Sports News 100% of general

ESPN.com 90%
other news 10%

Basketball 15%

NBA 20% of Basketball

Dallas Mavericks 60% of NBA
dallasbasketball.com 100% of Dallas

Mavericks

Other 20% of NBA
NCAA 60% of Basketball

Texas Longhorns 100% of NCAA
News 20% of Basketball
Texas Longhorns 70% of NCAA

texas.edu= 100% of Texas Longhorns
Other 30%.

Jennifer has the following sports scores and categories.

Sports: 20% of all activity

Football: 80% of all sports activity

NFL: 100% of football

Dallas Cowboys 95% of NFL
Assorted Cowboys sites

Other 5% of NFL

General: 10% of all sports activity

Sports News 100% of general

ESPN.com 90%
other news 10%
Basketball 10%

NBA 80% of Basketball

Dallas Mavericks80% of NBA
dallasbasketball.com 100% of Dallas Mavericks
Other 20% of NBA
News 20% of Basketball.

Given the above percentages identified from user web access, application usage and other user actions conducted through the user device, the users should be ranked as follows with James as the primary user of user of interest, the others below represent the relevancy to the primary user James:

1) David

2) Michael

3) Jennifer.

In this example, David and James have the closest “sports” score but Michael and James have the closest “football” score with “NCAA” dominating so Michael and James should match best, however since the lower level categories or sub-categories under NCAA don't match for Michael and James, the score is closer to David's score since David and James have the closest scores to each other in NCAA and then Texas A&M. Therefore, the relevancy of the sub-category for David and James takes priority over the category matching due to a better result as a certain match as opposed to a broad or general match.

In another example, using Michael as the primary user, Michael's matches should be ordered as follows:

1) Jennifer

2) James

3) David.

This order for Michael is determined because the closest scores on “NFL” were identified and if the demographics were given more weight, then maybe Michael and James would be the closest match because of gender but maybe Jennifer and Michael are closer than Michael and James on age so demographics are moot in this example. There are variations in the approaches used to identify relevancy scores among the users and to rank the users for a particular user of interest. When performing matching based upon URL domains or categories, then those may be worth more points because at some level you have to look at the overall interest in the top level category and the lower level sub-categories.

Every category/sub-category and subdomain will have a default group which will be offered to users based upon how they score. Users can then also create their own groups that contain matching criteria which can be one or more categories, geo-fencing, timed-criteria, demographics. Users will be automatically matched with these groups and offered the ability to join/follow the group.

The user will be scored in every category/sub-category and that their actual domain/URL level visits will also be part of the process. The lower down the category/URL tree the higher the score will be for matching the user. As a result, two people could be football fans and match at that level but one could be a professional and the other a NCAA fan so they would not score as highly as two users that were both pro football fans. The users' comparative score would go up even more if they both visited the same football websites or used the same football related apps.

Among the various existing social network platforms, FACEBOOK provides a direct application interface to integrate into the present application, however, all social network users will be able to share their application profiles with each other so that “friends” or even friends of friends can be identified and more information can be identified about those profiles and provided to the users. Also the application will aggregate the data for social connections so group data about those connections can also be identified and used to suggest and create new groups.

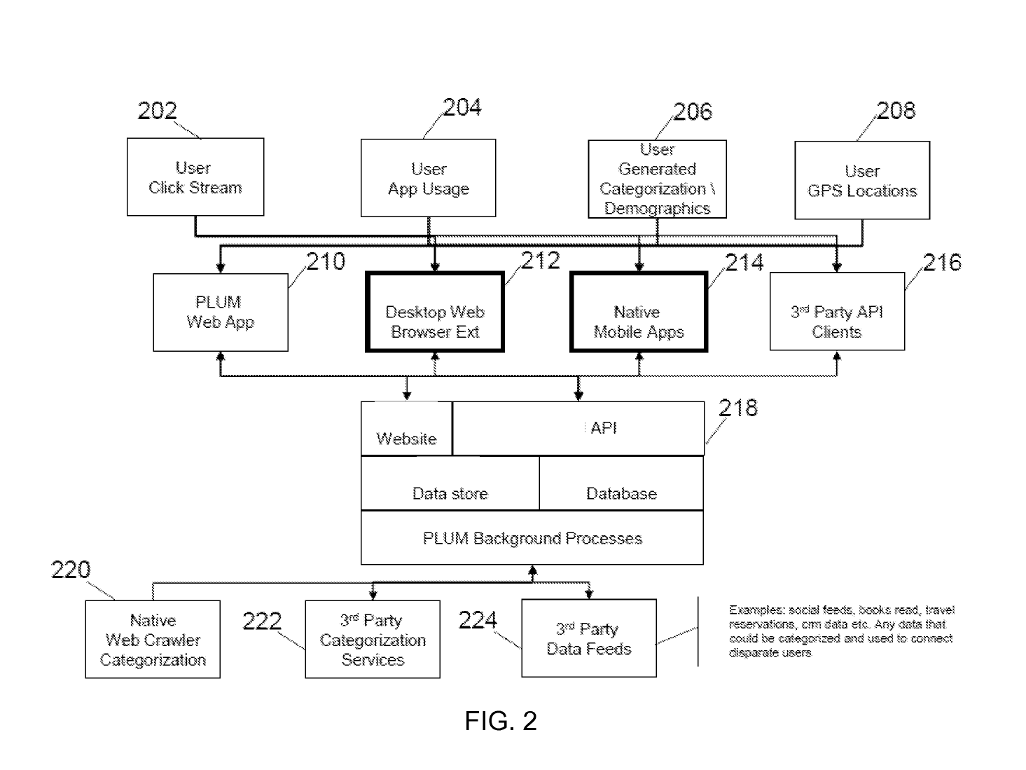

FIG. 2 illustrates an example of the application integrating with 3^{rd} party feeds. Referring to FIG. 2, the various user parameters being identified may include user web selections and clicks 202, application usage 204, user generated categories and user information, such as demographics 206 and user location 208. All of those parameters can be variables in a user profile and matching operation with other users for relevancy scores. The application may include a web portion 210, a desktop browser extension 212, a native application for a mobile device 214 and a 3^{rd} party API client 216. The application configuration stack 218 includes the website, the API, the database, the data store and the background processes as part of the application function. The third party components may include a native web crawler for categorization 220, a 3^{rd} party categorization server 222 and a 3^{rd} party data feeds 224.

In one example, the 3rd party feeds include data that can be received from outside data sources including a company that might connect an existing user account with the user's application account and permit specific data that only the company would normally provide to users. For example, AMERICAN AIRLINES could recruit their ‘aadvantage’ frequent flier customers to use the application, and the ones that connect could have specific data included in their plum profile that would only match with other ‘aadvantage’ members in the application, such as favorite domestic and international travel destinations, frequency of flying and/or priority level.

Additional inputs that could be added to the scoring and matching algorithms may include group affiliations and other known variables used together. For instance, if the two users are members of the Rotary club or group and Rotary has some extra information about these users such as years of membership, donation levels, status, rank, etc., then that information could be added to the demographics part of the scoring but the data would be provided from the 3^{rd} party. Continuing with the same example, the Rotary group would send out an invite to their user base to join the application of the present disclosure. Each user would receive a customized link. Rotary would provide the extra data to the application and it would be matched up with the users who have the application profile. Rotary would then see group analytics with these added data points and could become a top-level category and users could find other users in the Rotary category and use the special inputs and filters to commingle and setup invitations based on interests. Users could also setup special groups and use these extra inputs as group filters.

Continuing with the same example, the Rotary group would send out an invite to their user base to join the application of the present disclosure. Each user would receive a customized link. The Rotary group would provide the extra data to the application and it would be matched with the users who have the application profile. Rotary group would then see group analytics with these added data points and could become a top-level category and users could find other users in the Rotary category and use the special inputs and filters to commingle and setup invitations based on interests. Users could also setup special groups and use these extra inputs as group filters.

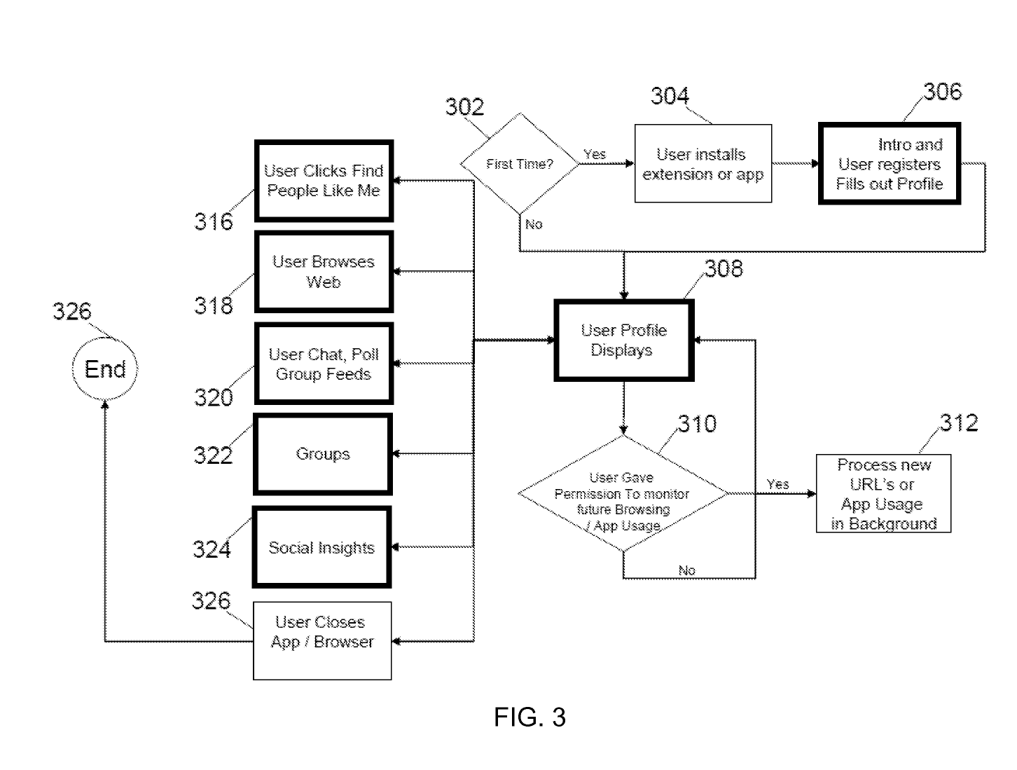

FIG. 3 illustrates a logic diagram of the operations and entities communicating as part of the user application according to example embodiments. Referring to FIG. 3, the user access functions initiate with a decision as to whether this is the first time the user has accessed the application 302. The result would be an install 304 and introduction and setup of user profile information. If not, the user proceeds to the profile display 308 which has a dashboard or other interface for user access. Then a determination is made 310 as to whether the user gave permission to monitor future browsing and application usage which is generally required for analysis. The process then continues to identify new URLs or application usage in the background 312. Thereafter any one or more of the following activities and functions may be identified including user selections for finding similar users 316, browsing the web 318, chatting and polling group feed 320, identifying groups 322, social insights 324 and closing the application or browser 326 which ends the process.

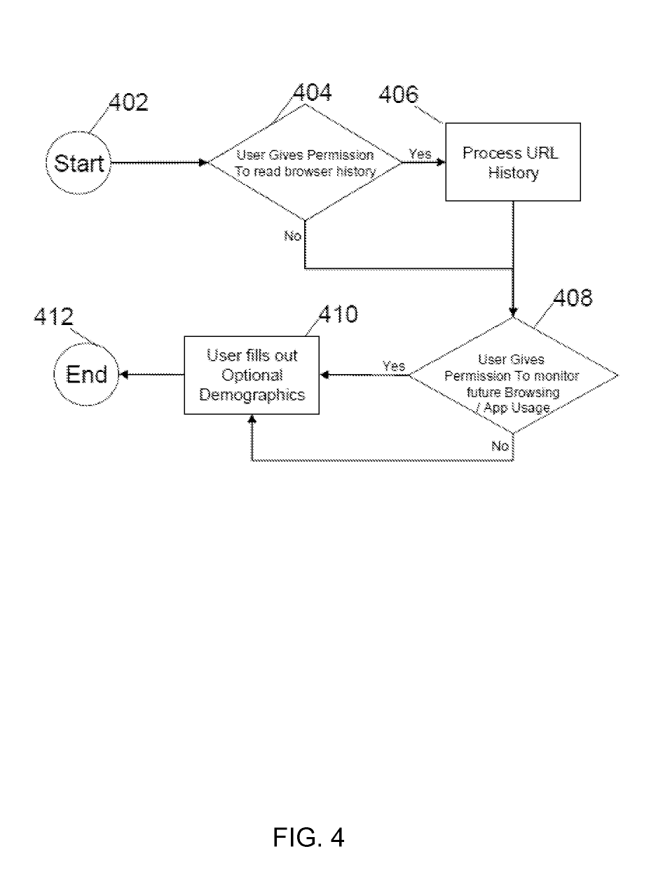

FIG. 4 illustrates a logic flow diagram of the operations of the user accessing the application according to example embodiments. Referring to FIG. 4, the start of the operation 402 includes the user giving permission to read the browser history 404 and then the URL can be processed to include in the user history 406. If there is not permission, then the user may be prompted to provide permission to monitor future browsing application usage 408. The user may then further include optional demographic information and/or interest information to include in the user profile 410. The process is then completed for user profile setup 412.

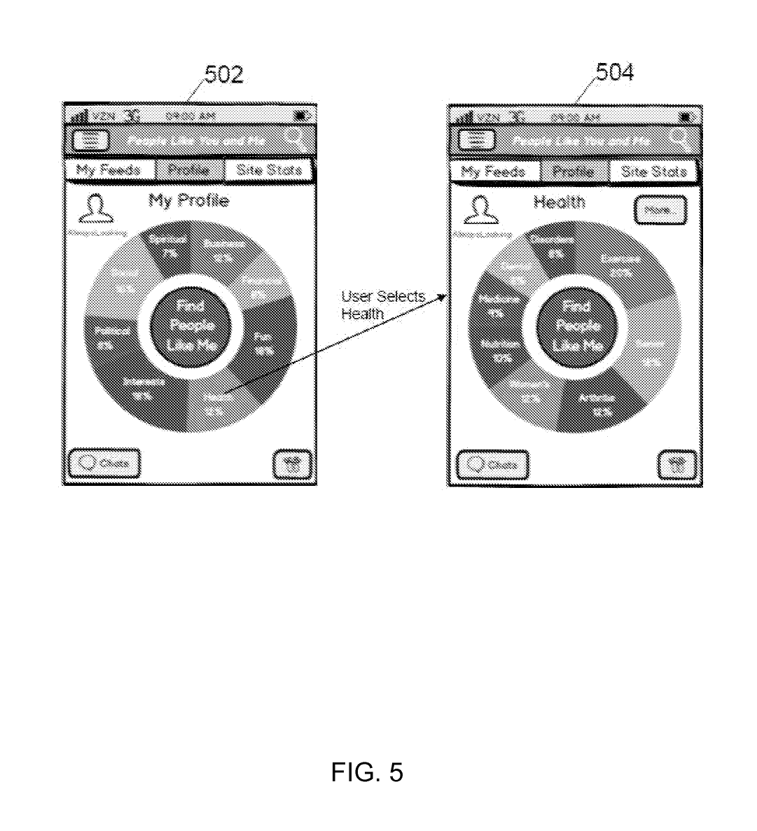

FIG. 5 is a user interface configuration used to drill down results from known information sources according to example embodiments. Referring to FIG. 5, in this example there are eight top level categories 502 as shown with various groups by spiritual/political/business/social/financial/fun/health/interes is etc. for a particular user. Each of these top level categories will lead to other sub-categories and sub-sub-categories and so on and so forth. For example, categories such as interests may lead to sports as a sub-category with football, basketball, soccer as sub-sub-categories and NCAA football as a sub-sub-sub-category depending on how the category hierarchies are setup. In this example, the user has selected health which provided 8 more sub-categories 504 for health including disorders, exercise, dental, senior, arthritis, women's, nutrition, and medicine.

Users can directly chat with other people found either individually or in a group chat. The application will notify the person that they have new chats to view or participate within. Groups may be group chats that continuously look for people that fit the filtering criteria. When using proximity or geo-fencing you can have users come into and out of the groups.

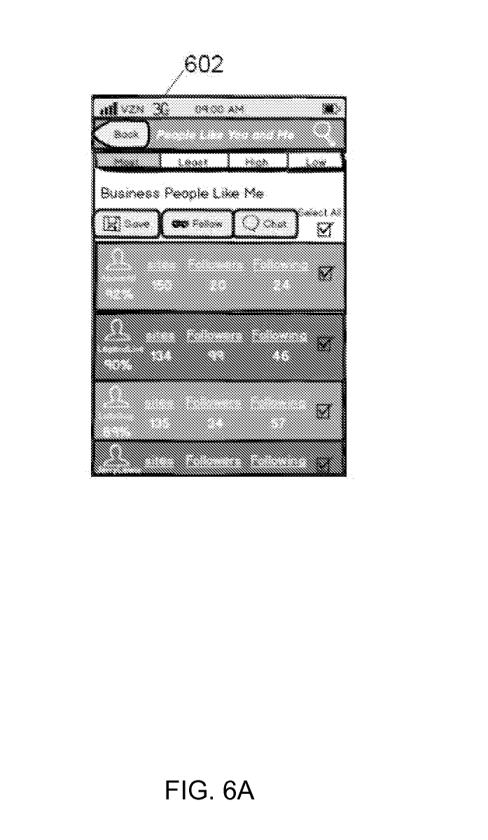

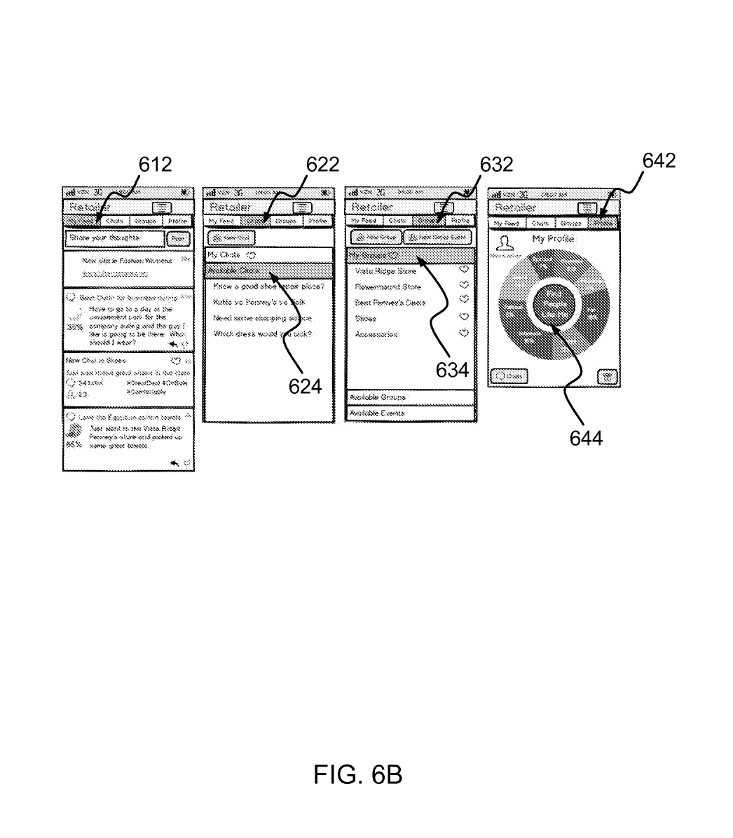

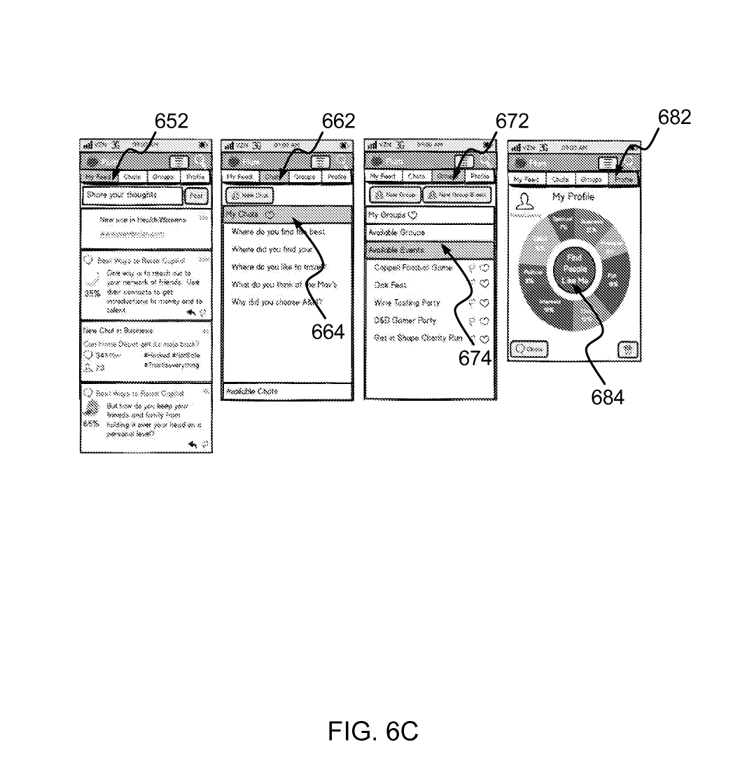

FIG. 6A illustrates another user interface for a user of the application according to example embodiments. Referring to FIG. 6A, the interface 602 includes a set of users who have similar profiles to the user of the application. Once those users are identified, the user of the application may select them for suggestions, chat, etc.

FIG. 6B illustrates an example user interface of a user set of menu options for accessing and enabling multiple users of the application according to example embodiments. In this example, a company/retailer or other organization can manage a community of their customers and create brand specific groups and events, etc. Referring to FIG. 6B, the first user interface screen provides a feed 612 of recent information related to the retailer company that can be accessed and which is updated frequently to reflect the new information made available or accessible to the user. The chat option 622 includes a series of available chats available 624 at any particular time. The groups option 632 includes a set of blogs or user groups 634 which are accessible by any of the users subscribed to the service. The last option 642 is the profile of the user who can select the find others tab 644 to drill down the other users to identify those with similar profiles and interests.

FIG. 6C illustrates another example user interface of a user set of menu options for accessing and enabling multiple users of the application according to example embodiments. In this example, the user feed 652, the user chats 662, the user groups 672 and the user profile 682 are all based on the general user interests of the user as the details include a list of interest chats 664, various different events 674 and the option to find other 684 based on varying interests in criteria. The user does not have to be in a particular company configuration as the above-noted example is the default user presentation interface without any specific affiliate being implemented.

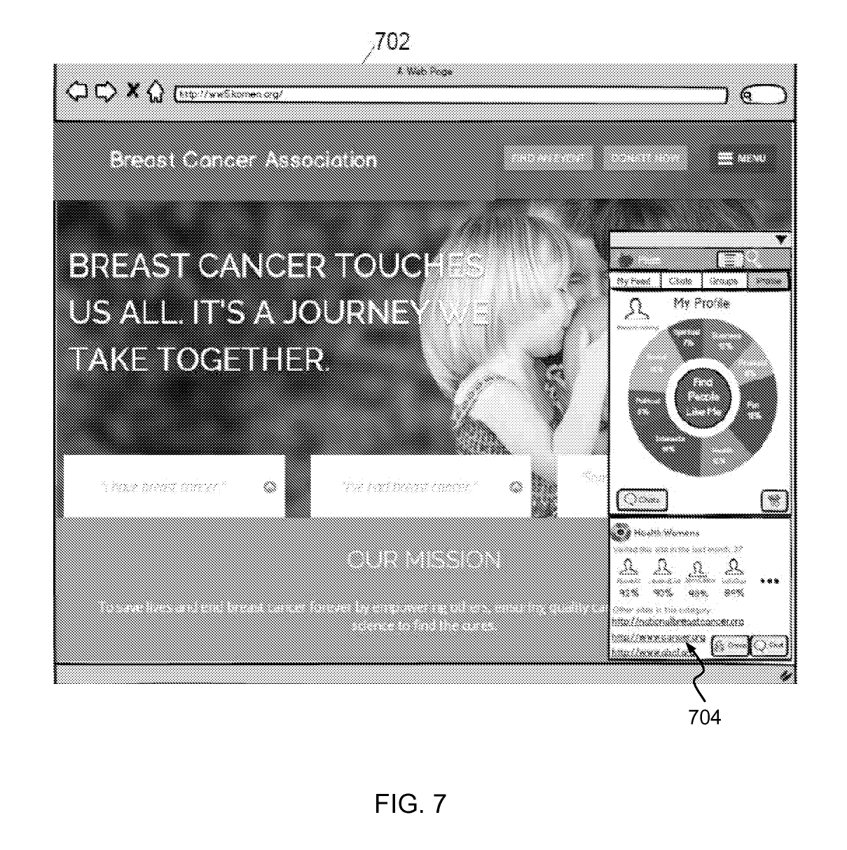

In FIG. 7, the user interface includes a web URL for a cancer site 702 with a list of overlaid users and profiles at the bottom portion 704. Those results include the most relevant users and the option to follow and/or chat with those users. The interests of each of the users identified are linked to the subject matter of the web page.

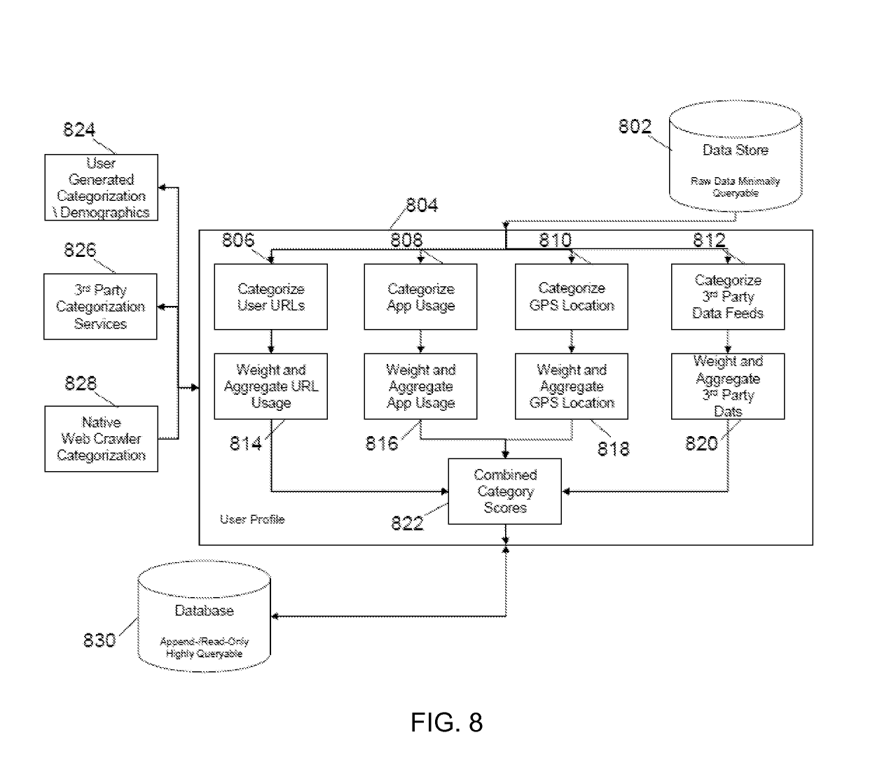

FIG. 8 illustrates an example logic diagram with categorization of user attributes according to example embodiments. Referring to FIG. 8, the user profile information 804 includes various user actions and attributes including categorized user URLs accessed 806, application usage 808, GPS location 810, and 3^{rd} party data feeds 812. Each of those data sources has a corresponding weight function 814, 816, 818 and 820, respectively, which assigns a weight to the data and aggregates the data. The combined scores 822 may be calculated from each of the weights and forwarded to a database for storage 830. The data used in the calculations may be retrieved from the data store 802. The other input sources may include user generated categorization 824, 3^{rd} party categorization services 826 and native web crawler data 828. The combination of data sources and calculation modules provides a basis for user profile updating and comparison of various user data profiles.

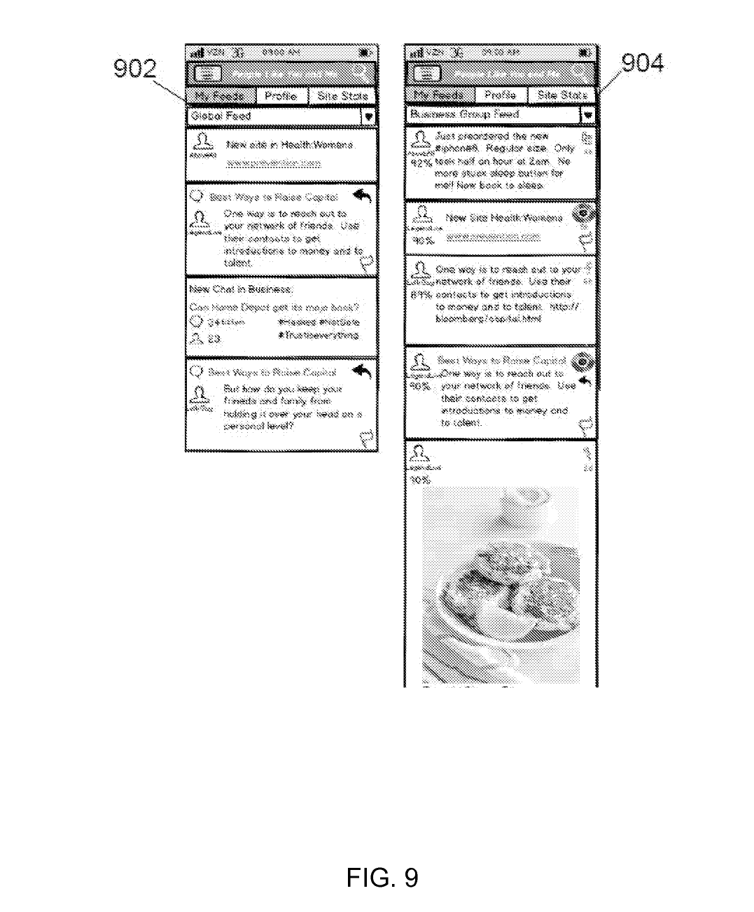

FIG. 9 illustrates a user interface of a user group feed and business group feed according to example embodiments. Referring to FIG. 9, the global feed 902 includes various user interests chat sessions and in the other feed 904, the various users are shown with certain degrees of relevancy to the user profile.

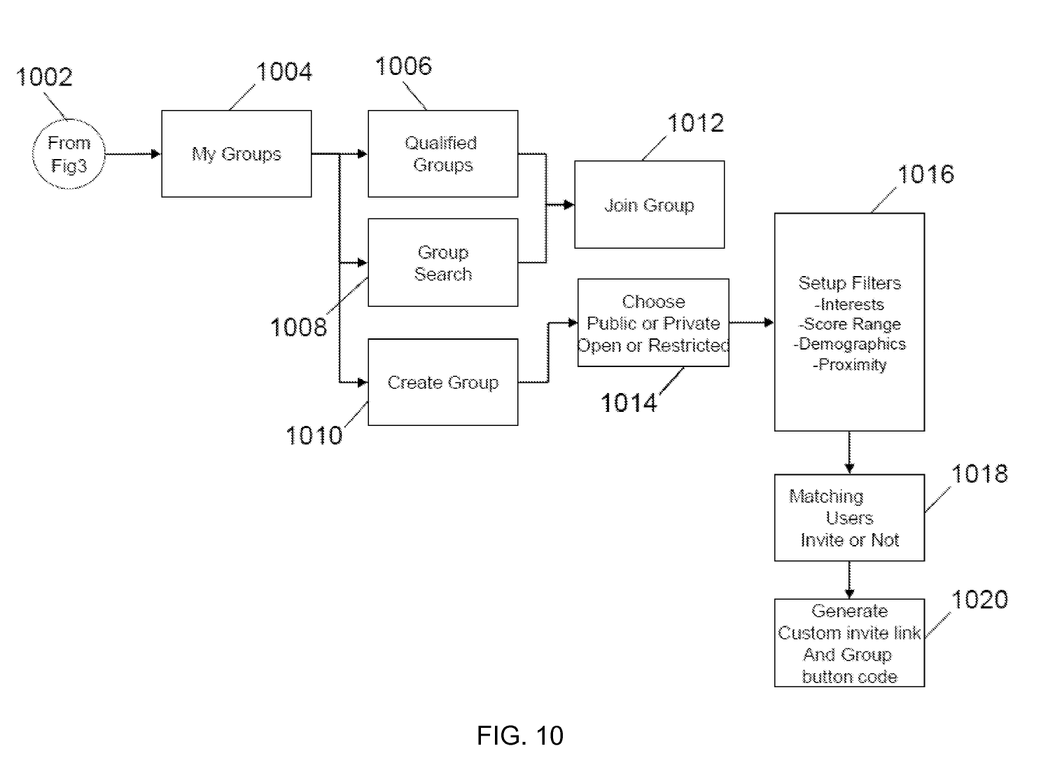

FIG. 10 illustrates a logic diagram of a group identification procedure according to example embodiments. Referring to FIG. 10, the examples from FIG. 3 may be provided 1002 to a set of groups 1004 which may include qualified groups 1006 based on comparison criteria, group search functions 1008 and a group creation function 1010. The groups which are discovered may be setup with a join group 1012 function. Those which are created may be configured to be private or public or open or restricted 1014. The group may have certain filters 1016 including interests, score range requirements, demographics, and/or proximity filters used to limit the group participants. The users that match may receive an invite 1018 and the invite links can then be generated along with access codes 1020 which are distributed to the intended invitees. The invite link is for creating a group and inviting people. For instance, a Rotary group would be invited to join the application and the Rotary group included in the same group cluster.

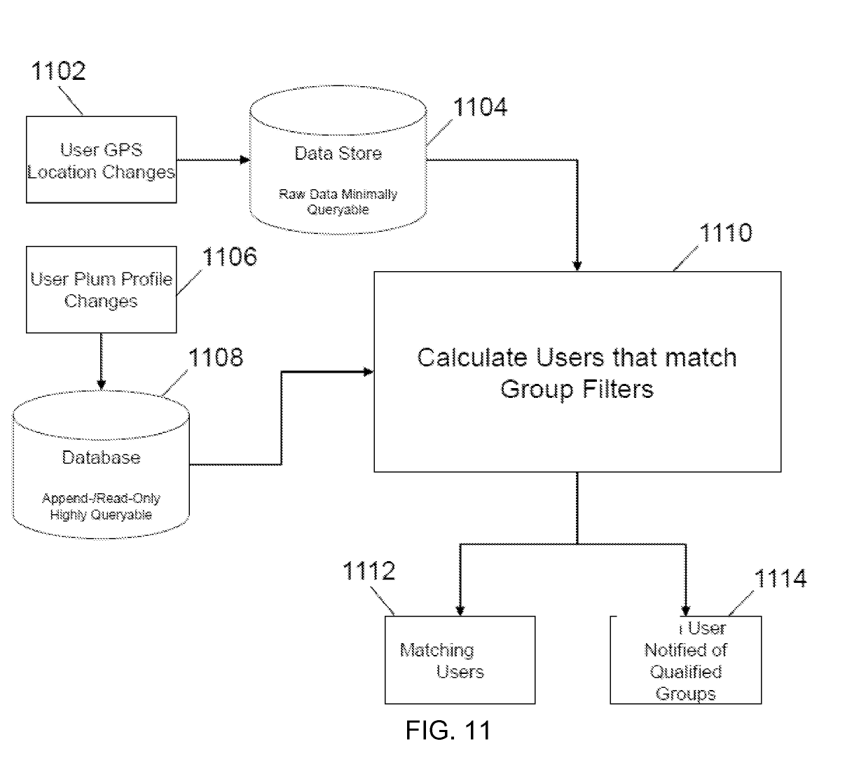

FIG. 11 illustrates a logic diagram of user group setup operations according to example embodiments. Referring to FIG. 11, the user may encounter a dynamic change in user information or user attributes which initiates a new group selection opportunity. For example, as the user device GPS location changes 1102, the data store 1104 is updated to provide new data to calculate users that match group filters 1110. The user profile changes 1106 and the database is updated to reflect the changes 1108. The matching users 1112 are identified and notified of the qualified groups 1114 based on the commonalities between the user and the matching users.

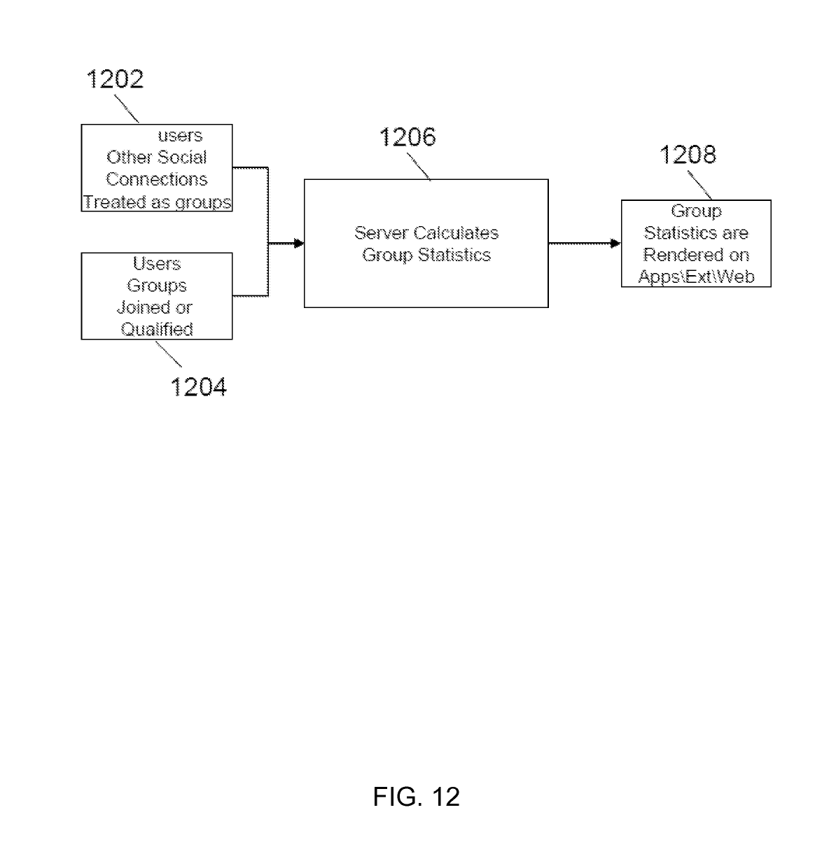

FIG. 12 illustrates another logic diagram with group calculations being performed. Referring to FIG. 12, the users social connections are treated as groups 1202 and the user groups are joined or qualified 1204. The server may calculate statistics for the various groups 1206. The group statistics are then rendered on the applications 1208. The users can then qualify for various groups which are offered to the users based on the recently identified group statistics.

In one example, the interest categories/sub-categories that the group is defined for may be used as the basis for determining qualified users based on the range of a user's score within one or more of the group defined categories. Also, demographics, location/geo-fencing. For instance, if the group is for hikers and bird watchers that go into Coppell park, the user can view the group information any anytime but they can only post while they are in the park for instance as limited by the geo-fencing rule. Other criteria may include 3^{rd} party data such as donation levels, membership years, application usage, specific domains visited, event time the group is supposed to attend an event. In one example, women who like basketball and who are at the Dallas Mavericks game against the Cleveland Cavaliers can be offered a group to join during the game so they can participate with an all-women real-time group chat.

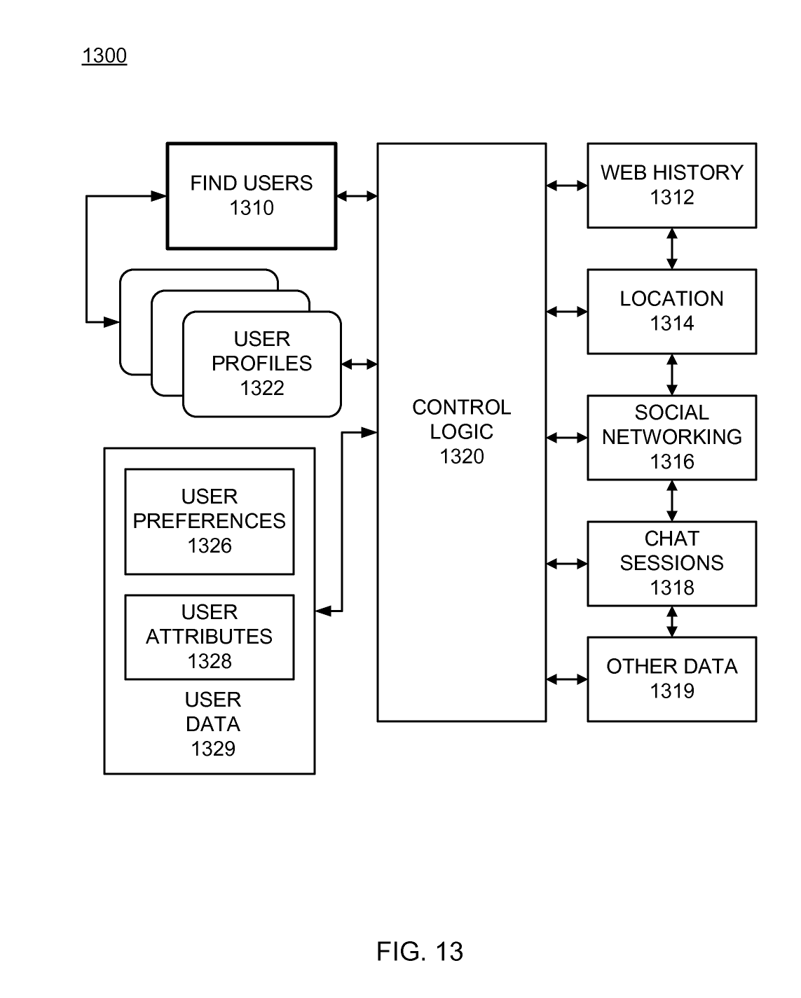

FIG. 13 illustrates a data logic diagram of the data inputs and processor logic according to example embodiments. Referring to FIG. 13, the logic configuration 1300 includes a control logic 1320 processor which receives as input a command to find other users 1310 from a first user device. The various user profiles 1322 may then be retrieved and the various user attributes can then be identified for each user to calculate a relevancy score, weight the attributes and compare the results for a ranking of relevant users. The information for each user may include web history 1312, location 1314, social networking activity 1316, chat sessions 1318 and other data 1319 considered relevant to the user profiling effort. Also, user preferences 1326 may be applied along with user attributes 1328 of the user data 1329 for the primary user. This configuration enables the primary user to be used as the basis or comparing entity for the group identification and communication efforts with other users.

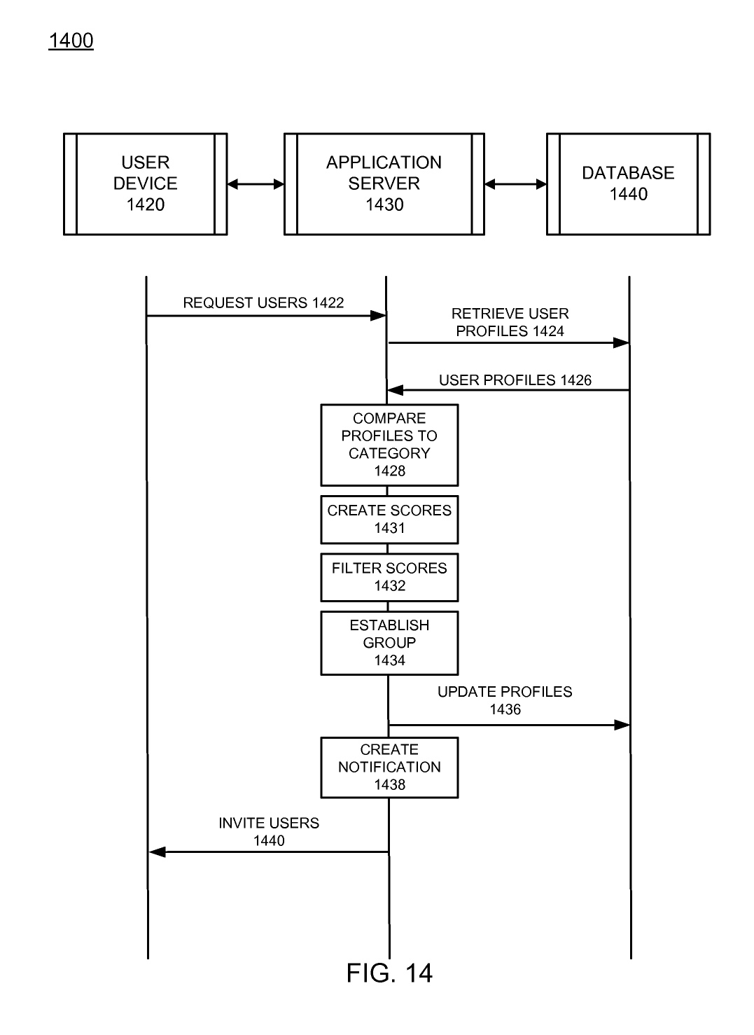

FIG. 14 illustrates a system signaling communication diagram 1400 of the types of communication messages exchanged between the user devices 1420, the application server 1430 and the database 1440. In operation, the primary user device 1420 may request users 1422 with like-mindedness or other attributes which are indicators of the type of group to create and offer to those users. For instance, the application server 1430 may retrieve stored information regarding user attribute, profiles and other information 1424 from the database 1440. The profiles 1426 are returned and used to perform various calculations at the server 1430 including identifying a plurality of user profiles, comparing the plurality of user profiles to a predetermined category 1428, creating a plurality of numerical scores 1431 corresponding to each of the plurality of user profiles, filtering the plurality of numerical scores based on a predetermined threshold value 1432, and establishing a group for the user profiles which are above the predetermined threshold value 1434. Also, the profiles may be updated 1436 and a notification can be created 1438 and sent to the various users 1440 inviting them to join the group.

In greater detail, creating the plurality of numerical scores further includes identifying application usage of a third party application associated with the user profiles, and identifying uniform resource locator (URL) access associated with the user profiles. Additionally, comparing the user profiles to a predetermined category further includes identifying at least one sub-category between at least two of the user profiles that exceeds the predetermined threshold value, and ranking the users based on the at least one sub-category provides a basis for determining user profile relevancy to the primary user requesting such information. Also, the user attributes may include web history, application usage history, user preferences, previously assigned groups, social networking data, demographic information, occupation information, user interests. Lastly, weights may be assigned to the one or more attributes.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

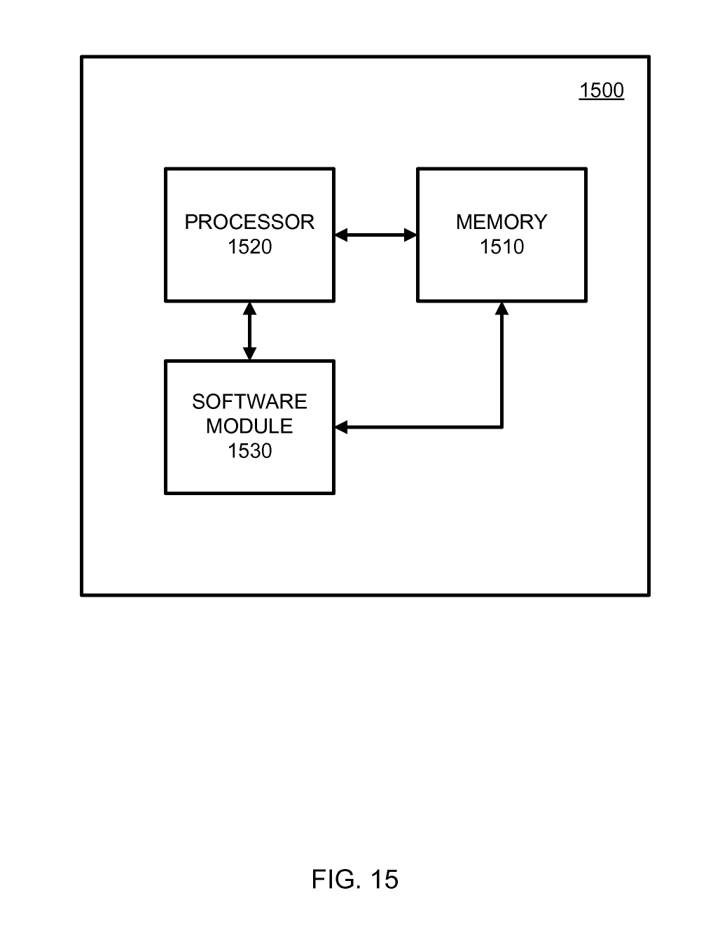

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 15 illustrates an example network element 1500, which may represent any of the above-described network components of the other figures.

As illustrated in FIG. 15, a memory 1510 and a processor 1520 may be discrete components of the network entity 1500 that are used to execute an application or set of operations. The application may be coded in software in a computer language understood by the processor 1520, and stored in a computer readable medium, such as, the memory 1510. The computer readable medium may be a non-transitory computer readable medium that includes tangible hardware components in addition to software stored in memory. Furthermore, a software module 1530 may be another discrete entity that is part of the network entity 1500, and which contains software instructions that may be executed by the processor 1520. In addition to the above noted components of the network entity 1500, the network entity 1500 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying a plurality of user profiles stored on a server;
comparing the plurality of user profiles to a predetermined category;
creating a plurality of numerical scores corresponding to each of the plurality of user profiles;
filtering the plurality of numerical scores based on a predetermined threshold value; and
establishing a group for the user profiles which are above the predetermined threshold value.

2. The method of claim 1, wherein creating the plurality of numerical scores further comprises:
identifying application usage of at least one third party application associated with the user profiles; and
identifying uniform resource locator (URL) access associated with the user profiles.

3. The method of claim 1, wherein comparing the plurality of user profiles to a predetermined category further comprises:
identifying at least one sub-category between at least two of the plurality of user profiles that exceeds the predetermined threshold value; and
ranking the plurality of users based on the at least one sub-category.

4. The method of claim 1, further comprising:
identifying at least one attribute for each of the plurality of users.

5. The method of claim 4, wherein the at least one attribute comprises web history, application usage history, user preferences, previously assigned groups, social networking data, demographic information, occupation information, search keywords, user interests.

6. The method of claim 4, further comprising:
assigning a weight to the at least one attribute.

7. The method of claim 1, further comprising:
transmitting invite messages to user devices associated with the user profiles which are above the predetermined threshold value.

8. An apparatus comprising:
a processor configured to
identify a plurality of user profiles stored on a server,
compare the plurality of user profiles to a predetermined category,
create a plurality of numerical scores corresponding to each of the plurality of user profiles,
filter the plurality of numerical scores based on a predetermined threshold value, and
establish a group for the user profiles which are above the predetermined threshold value; and
a transmitter configured to transmit invites to user devices associated with the user profiles.

9. The apparatus of claim 8, wherein to create the plurality of numerical scores further comprises the processor being configured to
identify application usage of at least one third party application associated with the user profiles; and
identify uniform resource locator (URL) access associated with the user profiles.

10. The apparatus of claim 8, wherein to compare the plurality of user profiles to a predetermined category further comprises the processor being configured to
identify at least one sub-category between at least two of the plurality of user profiles that exceeds the predetermined threshold value; and
rank the plurality of users based on the at least one sub-category.

11. The apparatus of claim 8, wherein the processor is further configured to
identify at least one attribute for each of the plurality of users.

12. The apparatus of claim 11, wherein the at least one attribute comprises web history, application usage history, user preferences, previously assigned groups, social networking data, demographic information, occupation information, search keywords, user interests.

13. The apparatus of claim 11, wherein the processor is further configured to assign a weight to the at least one attribute.

14. A non-transitory computer readable medium configured to store instructions that when executed causes a processor to perform:
identifying a plurality of user profiles stored on a server;
comparing the plurality of user profiles to a predetermined category;
creating a plurality of numerical scores corresponding to each of the plurality of user profiles;
filtering the plurality of numerical scores based on a predetermined threshold value; and
establishing a group for the user profiles which are above the predetermined threshold value.

15. The non-transitory computer readable medium of claim 14, wherein creating the plurality of numerical scores further comprises:
identifying application usage of at least one third party application associated with the user profiles; and
identifying uniform resource locator (URL) access associated with the user profiles.

16. The non-transitory computer readable medium of claim 14, wherein comparing the plurality of user profiles to a predetermined category further comprises:
identifying at least one sub-category between at least two of the plurality of user profiles that exceeds the predetermined threshold value; and
ranking the plurality of users based on the at least one sub-category.

17. The non-transitory computer readable medium of claim 14, wherein the processor is further configured to perform:
identifying at least one attribute for each of the plurality of users.

18. The non-transitory computer readable medium of claim 17, wherein the at least one attribute comprises web history, application usage history, user preferences, previously assigned groups, social networking data, demographic information, occupation information, search keywords, user interests.

19. The non-transitory computer readable medium of claim 17, wherein the processor is further configured to perform:
assigning a weight to the at least one attribute.

20. The non-transitory computer readable medium of claim 14, wherein the processor is further configured to perform:
transmitting invite messages to user devices associated with the user profiles which are above the predetermined threshold value.
